(19) United States
(12) Patent Application Publication
(10) Pub. No.: US 2026/0195171 A1
(43) Pub. Date: Jul. 9, 2026

(54) DYNAMIC JOB MONITORING FOR HETEROGENOUS SYSTEMS

(71) Applicant: International Business Machines Corporation, Armonk, NY (US)

(72) Inventors: Sumanth Vishnu Madyalkar, Bangalore (IN); Feng-wei Chen, Cary, NC (US); Sudarshana K S, Chickmagaluru (IN); Bilal Abdullah, New Delhi (IN)

(73) Assignee: International Business Machines Corporation, Armonk, NY (US)

(21) Appl. No.: 19/009,617

(22) Filed: Jan. 3, 2025

(51) Int. Cl. G06F 9/48

(52) U.S. Cl. CPC G06F 9/4881

(57) ABSTRACT

An embodiment establishes a system monitoring database, the system monitoring database configured to store data corresponding to one or more jobs. The embodiment registers metadata associated with a first job. The embodiment generates a monitoring activity corresponding to the first job based on the metadata associated with the first job. The embodiment generates a first event corresponding to the monitoring activity, the first event comprising a status of the first event. The embodiment captures a first output of a target system during execution of the first job over the target system. The embodiment comparatively computes the first output of the target system during execution of the first job over the target system to the status of the first event to determine a progress state of the first job. The embodiment initiates a responsive action based on the progress state of the first job.

### BACKGROUND

The present invention relates generally to system monitoring. More particularly, the present invention relates to a method, system, and computer program providing on-demand dynamic monitoring of long running jobs across heterogeneous systems.

Job monitoring refers to the process of overseeing and tracking the progress, status, performance, and behavior of tasks or jobs within a computing system or network environment. Job monitoring typically involves continuously monitoring job execution, identifying critical checkpoints, detecting anomalies or deviations from expected behavior, and ensuring that tasks are completed successfully and within the specified parameters. Job monitoring aims to provide real-time visibility into the execution of tasks, enabling administrators to proactively manage and optimize job performance, allocate resources efficiently, and respond promptly to any issues or failures that may arise during the execution of jobs across a system or network.

A heterogeneous system refers to a computing environment composed of diverse hardware, software, or network components that differ in terms of architecture, operating systems, programming languages, or protocols. In a heterogeneous system, multiple technologies and platforms coexist, requiring interoperability and communication between different systems to function effectively. These systems may vary in performance capabilities, data formats, and communication protocols, posing challenges for integration, data exchange, and system management. Heterogeneous systems often involve a mix of on-premises and cloud-based infrastructure, requiring specialized solutions to ensure seamless operation and coordination across the diverse components within the system environment.

Artificial intelligence (AI) technology has evolved significantly over the past few years. Modern AI systems are achieving human level performance on cognitive tasks like converting speech to text, recognizing objects and images, or translating between different languages. This evolution holds promise for new and improved applications in many industries, including system monitoring. For example, AI may be leveraged to predict the most effective monitoring parameters for a job. By continuously learning from new data and adjusting predictions based on real-time inputs, AI can dynamically optimize parameters to ensure efficient and proactive job monitoring.

An Artificial Neural Network (ANN)—also referred to simply as a neural network—is a computing system made up of a number of simple, highly interconnected processing elements (nodes), which process information by their dynamic state response to external inputs. ANNs are processing devices (algorithms and/or hardware) that are loosely modeled after the neuronal structure of the mammalian cerebral cortex but on much smaller scales. A large ANN might have hundreds or thousands of processor units, whereas a mammalian brain has billions of neurons with a corresponding increase in magnitude of their overall interaction and emergent behavior.

### SUMMARY

The illustrative embodiments provide for dynamic job monitoring for heterogenous systems. An embodiment includes establishing a system monitoring database, the system monitoring database configured to store data corresponding to one or more jobs. The embodiment also includes registering metadata associated with a first job. The embodiment also includes generating a monitoring activity corresponding to the first job based on the metadata associated with the first job. The embodiment also includes generating a first event corresponding to the monitoring activity, the first event comprising a status of the first event. The embodiment also includes capturing the first output of a target system during execution of the first job over the target system. The embodiment also includes comparatively computing the first output of the target system during execution of the first job over the target system to the status of the first event to determine a progress state of the first job. The embodiment also includes initiating a responsive action based on the progress state of the first job.

Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a block diagram of an example processing environment including a dynamic job monitor module in accordance with an illustrative embodiment;

FIG. 3 depicts a block diagram of an example dynamic job monitor module in accordance with an illustrative embodiment;

FIG. 4 depicts a block diagram of an example system architecture of a dynamic job monitor module in accordance with an illustrative embodiment;

FIG. 5 depicts a block diagram of an example system architecture of a dynamic job monitor module in accordance with an illustrative embodiment;

FIG. 6 depicts a flowchart of an example process for job registration in accordance with an illustrative embodiment;

FIG. 7 depicts a flowchart of an example process for activity generation in accordance with an illustrative embodiment;

FIG. 8 depicts a flowchart of an example process for event generation and task processing in accordance with an illustrative embodiment;

FIG. 9 depicts a flowchart of an example process for event execution, parsing, and notification in accordance with an illustrative embodiment;

FIG. 10 depicts a flowchart of an example process for activity prediction in accordance with an illustrative embodiment;

FIG. 11 depicts a sequence diagram for dynamic job monitoring in accordance with an illustrative embodiment; and

FIG. 12 depicts a flowchart of an example process for dynamic job monitoring in accordance with an illustrative embodiment.

### DETAILED DESCRIPTION

In modern computing environments, job monitoring plays a crucial role in ensuring the efficient execution of tasks across a heterogeneous collection of systems. A heterogeneous system environment typically consists of diverse hardware, software, and network configurations, making it challenging to manage and monitor jobs consistently. These systems may vary in terms of operating systems, architectures, applications, and performance characteristics, leading to complexities in job execution and monitoring.

Job monitoring across a heterogeneous collection of systems involves overseeing the progress, status, and performance of tasks running on different platforms or different components of the same platform simultaneously. This monitoring process is useful for maintaining system reliability, optimizing resource utilization, and detecting and resolving issues that may arise during job execution. Organizations often employ robust disparate monitoring solutions to ensure operation and mitigate disruptions across their diverse systems, which may include a combination of on-premises, cloud-based, and hybrid infrastructure,

In a heterogeneous system environment, job monitoring processes face unique challenges such as interoperability issues, data inconsistencies, and varying monitoring capabilities across different systems. Monitoring tools must be capable of collecting and analyzing data from disparate sources, integrating with multiple monitoring protocols, and providing a unified view of job statuses and performance metrics across the entire system landscape.

Further, effective job monitoring across heterogeneous systems may benefit from a comprehensive approach that considers the diverse nature of the systems involved and may include implementing various monitoring solutions that can adapt to different technologies, protocols, and data formats, thereby enabling seamless communication and data exchange between systems. By standardizing monitoring practices and leveraging automation and machine learning techniques, organizations can streamline job monitoring processes, improve system visibility, and enhance decision-making based on real-time insights from across the heterogeneous system environment.

Further, in the era of automation, there are numerous activities that can take a significant amount of time, ranging from a few minutes to several hours, in order to complete their execution. During the execution period, various abnormal situations may occur, leading to halts or the activity remaining hung, thereby affecting job progress. These prolonged activities often require manual observation to monitor them at regular or irregular intervals until the job's ultimate completion of success or failure. The monitoring process typically involves analyzing the task's progress, determining whether it was successful or failed, no progress, and identifying any abnormalities in its behavior.

Limitations of currently existing system monitoring processes create constant need for human intervention that forces human users of the system to continuously monitor the status of these activities to determine whether they have been completed successfully or have encountered failures. Additionally, users often resort to alternative metrics or visual cues to estimate the progress of these activities. They may also rely on event notifications to understand the status of the tasks after their completion. This manual monitoring and analysis process consumes a substantial amount of human hours, as well as computer resources, as users wait for these tasks to complete.

Moreover, this manual approach culminates a subjective human experience, where users estimate time taken for such tasks based on their own observations. Consequently, there is a need for an efficient and automated method that can monitor, accurately estimate, track the progress, success, and abnormalities of these long-running activities, thereby reducing or even eliminating the need for manual intervention. Additionally, approaches, such as voice or chat operations, require a system that can detect and handle non-obvious situations within these heterogeneous systems, beyond simple timeouts. Such a system should also be capable of capturing human experiences for analytical, predictive and decision-making purposes.

Embodiments of the present disclosure consider the limitations of previously existing job monitoring systems stemming from the inherent variability in system behaviors and the lack of standardized monitoring practices. Each system may operate differently and may have unique characteristics that affect the time required to complete tasks. In some cases, non-obvious situations such as system hang-ups or lack of progress can occur, posing challenges for monitoring and troubleshooting. Existing systems often rely heavily on the experience and expertise of individuals who have worked with the system, leading to a knowledge gap when personnel changes occur. For example, if a new person takes over monitoring duties, they may struggle to interpret system behaviors or identify issues that were previously understood by the original operator, potentially leading to delays in problem resolution and impacting system performance.

Embodiments of the present disclosure address the limitations of existing job monitoring systems by capturing and translating previously subjective human experiences into objective metrics. By leveraging these metrics, example embodiments of the monitoring process disclosed automatically generate self-tuning and self-healing methods to enhance monitoring efficiency and effectiveness. In some embodiments, the self-tuning methods analyze the metrics to determine the optimal duration and frequency required for monitoring and taking action on various tasks. For instance, in scenarios like database backup during migration activities, the system can dynamically adjust monitoring parameters based on the specific requirements of the task. This approach eliminates the reliance on individual experience and ensures that monitoring processes are optimized and adaptive to the unique behaviors of each system, thereby enhancing system reliability and performance.

Embodiments of the present disclosure provide a centralized interface that may include a unified platform and tools that serves as a single point of access and control for managing and monitoring diverse components within a heterogenous system. This interface provides a consolidated view of the heterogeneous systems, allowing administrators to interact with and oversee different hardware, software, applications, and network elements from a centralized location. By offering a common interface for system management tasks, such as configuration, monitoring, troubleshooting, and reporting, a centralized interface simplifies the complexity of heterogeneous environments, enhances visibility and control, and facilitates seamless communication and coordination across the various components within the system architecture.

The present disclosure addresses the deficiencies described above by providing a process (as well as a system, method, platform, machine-readable medium, etc.) that develops a dynamic job monitoring system that considers unique characteristics of heterogenous systems deploying various jobs and records and leverages historical data to generate an optimal frequency and duration for interval based on demand job monitoring. Disclosed embodiments establish a centralized application programming interface (“API”) specifically configured to establish a connection between various components of a heterogenous system (or multiple systems) to monitor progress of long running jobs and automatically generate and/or initiate responsive actions upon identification of an abnormal situation arising during attempted completion of one or more jobs.

The illustrative embodiments provide for dynamic job monitoring for heterogenous systems. Embodiments disclosed herein describe a job as a long-running job, which may include any task or process within a computing system that may require a significant amount of time or steps to complete its execution. These jobs may involve complex operations, extensive computations, or large datasets, leading to prolonged processing durations. Long-running jobs may include data-intensive operations like data migration, batch processing, or data analysis to computational tasks such as simulations, modeling, or machine learning training. Examples of long-running jobs include, but are not limited to, running a complex database query that processes large volumes of data, executing a software build process that compiles and tests a large codebase, or performing a data backup operation that transfers a substantial amount of information to a storage system. It is understood that long-running jobs include jobs that comprise long-sequences of tasks to complete, as well as jobs with individual tasks that may take a long time to complete.

While specific examples of long-running jobs have been provided, it is important to note that the scope of the disclosure encompasses a wide range of job types beyond those mentioned. The term “long-running job” within this context includes various tasks and processes that require a significant amount of time to complete, regardless of their specific nature or industry. This encompasses not only traditional long-running jobs but also other types of tasks that may not typically be classified as long-running jobs. Additionally, sequences of jobs, workflows, or job chains that involve multiple interconnected tasks are also considered within the scope of the disclosure. These sequences may include dependencies, parallel processing, or conditional logic that governs the execution and completion of the jobs, contributing to the overall efficiency and effectiveness of job monitoring and management within the system. Additionally, although certain embodiments reference monitoring computer systems and network, it is understood that embodiments of the present disclosure may be modified for monitoring of any task in any industry, without departing from the spirit and scope of the present disclosure. Accordingly, embodiments of the present disclosure can be ready modified for any system which has the capability to send data or metrics in electronic form.

As used throughout the present disclosure, the term “heterogenous system” refers to a computing environment and/or network infrastructure that may include diverse hardware, software, and/or network components with varying characteristics, configurations, or technologies. In a heterogeneous system, different components may have distinct architectures, operating systems, programming languages, or communication protocols, leading to complexities in integration and interoperability. This diversity in components often requires specialized solutions to facilitate communication, data exchange, and coordination among the various elements within the system. Further, heterogeneous systems often include a mix of on-premises and cloud-based resources, which require consideration to manage and optimize system performance across the diverse components.

Embodiments of the present disclosure include identifying non-obvious situations such as progress or lack thereof during job execution and taking appropriate actions based on these observations. Further, embodiments of the present disclosure may be configured to detect anomalies, deviations, or unexpected behaviors that may indicate issues with job progress. By continuously monitoring job statuses and performance metrics, the system can distinguish between progressing and non-progressing tasks and trigger alerts or responses accordingly. Additionally, embodiments of the present disclosure may be designed to have capability to adjust the monitoring frequency and duration dynamically based on the observed behavior of the jobs. By analyzing historical data and real-time inputs, embodiments of the present disclosure can estimate the duration of completion for each job, allowing for proactive management and optimization of job execution timelines. This adaptive approach ensures that the monitoring system remains responsive to changing job conditions and can effectively predict and address potential issues to enhance overall job performance and efficiency.

An embodiment of the present disclosure comprises several components to address the inefficiencies in currently existing methods of monitoring long-running jobs and tasks. An embodiment includes a prime metadata registration module configured to enable input of any useful and/or essential metadata related to a long-running job. The metadata may include, but is not limited to, job identifiers, expected duration, critical checkpoints, and other relevant information useful for monitoring the progress of the tasks. An embodiment of the present disclosure includes a data dictionary stored on a job monitor database, such that the data dictionary enables registering new prime data for long running jobs, as well as enables reading data corresponding to previously registered prime data.

An embodiment includes a job module configured to read prime metadata stored on the job monitor database to generate one or more activities based on the prime metadata, as well as one or more events corresponding to the one or more activities generated. In an embodiment, an event includes initiating a monitoring process for a defined period of time for monitoring the activity. Accordingly, the job module may be configured to read metadata to generate an activity, and generate one or more events at defined intervals for the activity generated.

An embodiment includes an event module configured to capture the status for each event that has been generated corresponding to the activity generated based on the prime metadata registered by the users. In some embodiments, events may be triggered based on predefined criteria such as, for example, reaching a critical checkpoint, exceeding the expected duration, or encountering abnormal behavior during the job execution. In an embodiment, the status captured for each event that has been generated may include one or more metrics, key performance indicators, comprehensive assessments, or any other desired data based on implementation specific configuration.

An embodiment includes a task module configured to read the event, establish the connection to the target system, gather and record the output, parse the output, and compare to validate non-obvious status of the job till its completion or failure and update the status in the event module at every stage and finally record the execution result into the system. In an embodiment, the task module may be configured to continuously and/or iteratively monitor the progress of the long-running jobs based on the events generated. In an embodiment, the task module tracks the status of the tasks, compares them against the expected status or milestones, and provides real-time updates on the job's advancement. In an embodiment, the task module reads events, parse the event to identify key metrics, and analyze the key metrics to determine whether a job or task is progressing, not-progressing, hung, or some other unexpected and/or undesirable situation. By monitoring the progress, the system can identify any deviations from the expected behavior and take corrective measures.

An embodiment includes a response action module configured to initiate one or more responsive actions in response to detecting an abnormality and/or an event triggered during the job execution. Depending on the abnormality or nature of the event, the system can automatically take actions, such as for example, sending notifications to users, pausing or resuming the job, reallocating resources, interacting with another resource via API, or escalating the issue to higher authorities for intervention. By enabling users to register prime metadata, generating events, monitoring progress, and initiating responsive actions, the system enhances the efficiency and reliability of managing long-running jobs in automated environments.

Illustrative embodiments include establishing a system monitoring database, the system monitoring database configured to store data corresponding to one or more jobs. The illustrative embodiments also include registering metadata associated with a first job. The illustrative embodiments also include generating a monitoring activity corresponding to the first job based on the metadata associated with the first job. The illustrative embodiments also include a first event corresponding to the monitoring activity, the first event comprising a status of the first activity. illustrative embodiments also include capturing a first output of a target system during execution of the first job over the target system. The embodiment also includes comparatively computing the first output of the target system during execution of the first job over the target system to the status of the first event to determine a progress state of the first job. The illustrative embodiments also include initiating a responsive action based on the progress state of the first job.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

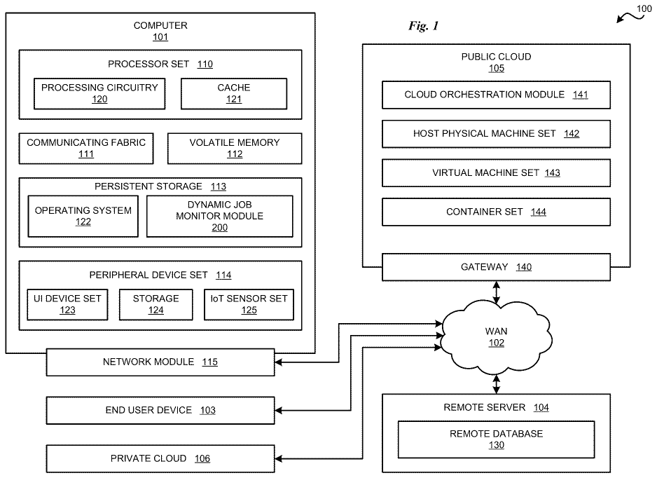

FIG. 1 depicts a block diagram of a computing environment 100. Computing environment 100 contains an example of an environment for the execution of at least some of the computer code involved in performing the inventive methods, such as dynamic job monitor module 200 that provides dynamic on-demand monitoring, anomaly detection, and automatic response initiation for heterogenous systems. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

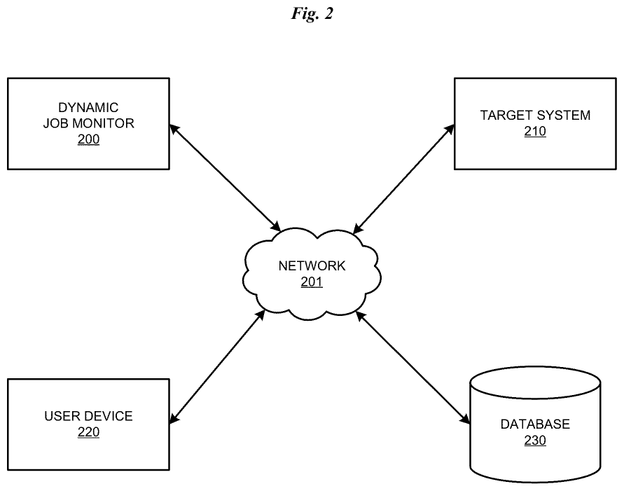

FIG. 2 depicts a block diagram of an example processing environment in accordance with an illustrated embodiment. In the illustrated embodiment, the dynamic job monitor module 200 of the depicted example processing environment includes dynamic job monitor module 200 of FIG. 1.

In the illustrated embodiment, dynamic job monitor module 200 is configured to establish a connection to target system 210 via any suitable network 201 and initiate one or more job monitoring processes to monitor one or more jobs running on target system 210. Upon establishing the connection to target system 210, the dynamic job monitor module 200 interfaces with the target system 210 to access any relevant and/or necessary job-related data and parameters. In an embodiments, the dynamic job monitor module 200 deploys one or more monitoring processes that continuously track and analyze the status, progress, and performance of one or more jobs running on the target system 210. In an embodiment, the job monitor module 200 may be configured to gather real-time job information related to jobs running on target system 210, receive status updates, and trigger alerts or actions based on predefined criteria to ensure efficient and effective monitoring of the jobs within the system. In an embodiment, the progress state indicates an expected execution result associated with the first job at a first moment in time. In an embodiment, the progress state indicates an unexpected execution result associated with the first job at a first moment in time. In some embodiments, upon indication of an unexpected execution result, an automatic responsive action is automatically initiated.

In the illustrated embodiment, the dynamic job monitor module 200 may be configured to register prime metadata associated with various jobs. Accordingly, once the metadata is entered, the module stores this information in a centralized database or repository, such as database 230, facilitating readily accessible data for job monitoring and analysis. By capturing and organizing prime metadata in a systematic manner, the system establishes a foundation for efficient job monitoring, enabling users to track and manage the progress of various tasks effectively. In an embodiment, job monitor module 200 and/or user device 220 communicates with various components of target system 210 and/or database 230 via an API gateway or a centralized API configured to interact with one or more other APIs via an API gateway.

In some embodiments, dynamic job monitor module 200 connects with an API gateway via any suitable network 201 or combination of networks such as the Internet, etc. and uses any suitable communication protocols such as HTTP, Wi-Fi, Bluetooth, etc. The API gateway may provide access to client applications like dynamic job monitor module 200. Further, the API gateway may receive service requests issued by client applications and creates service lookup requests based on service requests. As a non-limiting example, in an embodiment, user device 220 executes a routine to initiate interaction with dynamic job monitor module 200. For instance, in some embodiments, user device 220 executes a routine to instruct dynamic job monitor module 200 to monitor target system 210 and/or any other system, component, or aspect of network 201 according to embodiments described herein.

In the illustrated embodiment, user device 220 enables a user with sufficient privileges to interact with and/or modify parameters of the dynamic job monitor module 200. In an embodiment, user device 220 enables authorized users to manage and configure the monitoring system according to their roles and responsibilities. For example, a user with sufficient privileges may be able to perform various administrative tasks and modify parameters to optimize job monitoring processes. Some example admin features that a privileged user may be able to do include, but are not limited to the following. In an embodiment, a user can adjust monitoring parameters such as monitoring frequency, duration, and thresholds to align with specific job requirements and performance metrics. In an embodiment, a user may be able to define alert triggers and notification preferences to initiate automatic responses and/or receive real-time alerts for critical events, anomalies, or job failures detected by the monitoring system. In an embodiment, a user can prioritize jobs based on their importance, deadlines, or resource requirements to ensure efficient job scheduling and allocation.

Further, in an embodiment, an authorized user of user device 220 may be able to access real-time job status updates, performance reports, and historical data to track job progress, identify trends, and analyze system performance. Further, a user can customize monitoring dashboards to display relevant metrics, key performance indicators, and visualizations for quick insights into job statuses and system health. Also, users with administrative privileges can manage user access levels, roles, and permissions within the monitoring system to ensure data security and compliance. Further, the user can schedule automated tasks, including but not limited to, job executions, data backups, or system maintenance and/or repair (e.g., self-healing). By leveraging the features provided by user device 220, privileged users can effectively interact with and modify parameters of the dynamic job monitor module 200 to enhance monitoring capabilities, streamline operations, and ensure the efficient management of long-running jobs within the system.

In an embodiment, the dynamic job monitor module 200 incorporates one or more machine learning algorithms trained to predict an optimal frequency and duration for interval-based job monitoring. In an embodiment, the dynamic job monitor module 200 utilizes historical job data, including job statuses, durations, monitoring frequencies, and outcomes, to train machine learning models that can optimize the monitoring process. In an embodiment, the one or more machine learning algorithms leveraged by the dynamic job monitor module 200 may be designed, trained, configured, and/or fine-tuned to analyze patterns and relationships within the historical job data to predict the most effective monitoring parameters for interval-based job monitoring. In an embodiment, algorithms may consider various factors, including but not limited to, job complexity, resource availability, and critical checkpoints, etc. to generate predictions for the optimal frequency at which job statuses should be monitored and the duration for which monitoring should occur. In an embodiment, the job monitor module 200 leverages a regression model to generate predictions regarding optimal job monitoring frequency and/or duration.

Through continuous learning and adaptation, the machine learning algorithms may adjust their predictions based on real-time inputs and evolving job characteristics. By leveraging the predictive capabilities of one or more machine learning algorithms, the dynamic job monitor module 200 can dynamically optimize monitoring intervals and durations to ensure efficient and proactive job monitoring. This predictive approach enhances system performance, resource utilization, and the overall effectiveness of interval-based job monitoring in diverse and dynamic system environments.

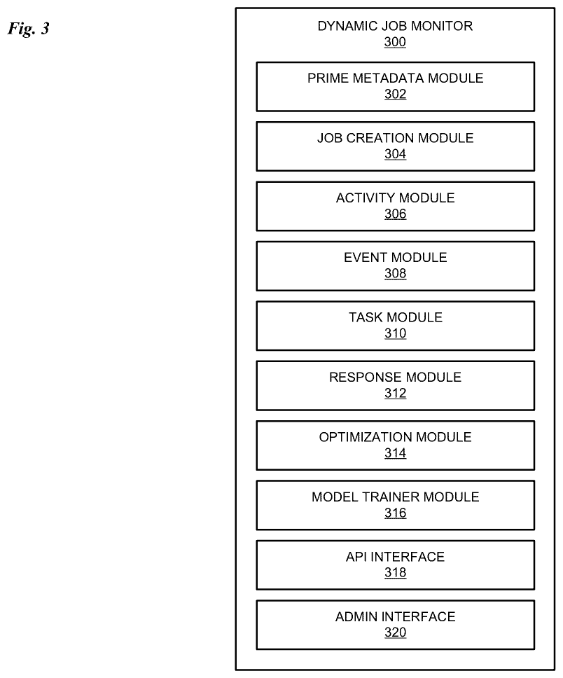

FIG. 3 depicts a block diagram of an example dynamic job monitor software module. In an embodiment, dynamic job monitor module 300 includes dynamic job monitor module 200 of FIGS. 1 and 2. In the illustrated embodiment, the dynamic job monitor module 300 includes a plurality of software modules configured to interact with each other to accomplish the example functions and processes described herein. In the illustrated embodiment, the dynamic job monitor module 300 includes a prime metadata module 302, a job creation module 304, an activity module 306, an event module 308, a task module 310, a response module 312, an optimization module 314, a model trainer module 316, an API interface module 318, and an admin interface module 320. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the prime metadata module 302 is configured to capture and store any metadata related to one or more long-running jobs. This module allows users to input key information such as job identifiers, expected duration, and critical checkpoints, and/or any other metrics related to monitoring progress of a job. In an embodiment, the prime metadata module interacts with the job creation module 304 to generate jobs based on the metadata collected and stored by the prime metadata module 302. In an embodiment, prime metadata module 302 enables a user to register prime metadata for long-running jobs by providing an interface for inputting relevant and/or essential job information. Further, through the user interface, individuals can specify the unique identifiers for each job, set the expected duration for job completion, define critical checkpoints that mark significant milestones in the job execution, and include any additional metadata that may impact the monitoring process.

In an embodiment, once the prime metadata is registered by the user, the prime metadata module 302 may store this information in a structured format within a repository of the system and thereby ensures that the registered metadata is easily accessible and retrievable for subsequent job monitoring processes. By centralizing and organizing the prime metadata, the prime metadata module 302 streamlines the monitoring setup and enhances the efficiency of tracking and managing disparate long-running jobs across various aspects of a heterogenous system.

In the illustrated embodiment, the job creation module 304 facilitates the creation of long-running jobs within a system. In an embodiment, the job creation module 304 utilizes the metadata provided by prime metadata module 302 to set up the parameters and requirements for each job. Once a job is created, the job creation module 304 may interact with activity module 306 to initiate the execution of the task. In an embodiment, job creation module 304 reads requests from various sources and generates events for tracking or monitoring, which may be activated or deactivated based on the request. In an embodiment, the job creation module 304 accesses the prime metadata registered for long-running jobs, which includes information such as job identifiers, expected durations, and critical checkpoints. Based on this metadata, the job creation module 304 generates events corresponding to activities that define the tasks and processes to be monitored during job execution. In an embodiment, once the activities are generated, the job creation module initiates monitoring by creating events at regular frequencies. In some embodiments, these events are triggered based on predefined criteria, such as reaching critical checkpoints, exceeding expected durations, or encountering anomalies in job behavior. By generating events at regular intervals, the job creation module ensures that the progress and status of the job are continuously and/or dynamically monitored and tracked throughout the execution process. Further, events generated by the job creation module may serve as indicators for the monitoring system to take further actions, such as updating job statuses, sending notifications to users, or triggering automated responses based on the event criteria. By creating events at regular frequencies, the job creation module enables real-time and on-demand monitoring of job activities.

In the illustrated embodiment, the activity module 306 is responsible for overseeing the execution of the long-running jobs. In an embodiment, the activity module 306 monitors the progress of each task, tracks milestones, and detects any abnormalities during the job execution. In an embodiment, the activity module 306 interacts with the event module 308 to generate events based on the job's progress and triggers alerts, notifications, and/or responsive actions when necessary. In an embodiment, the activity module 306 manages the status of activities for job monitoring. In an embodiment, the activity module 306 estimates the duration and/or frequency for each job that is activated.

In the illustrated embodiment, the event module 308 generates events based on predefined criteria such as reaching critical checkpoints, exceeding expected durations, or encountering anomalies. These events serve as triggers for the system to take responsive actions. In an embodiment, the event module 308 interacts with the task module 310 to update the status of the tasks as well as with the response module 312 to initiate appropriate actions. In an embodiment, event module 308 maintains the status of tasks and is updated by task module 310 as task execution progresses. In an embodiment, the task module reads active activities, generates a list of events matching the criteria, and assigns priorities for execution in a queue for the respective jobs. In an embodiment, the event module 308 (based on priorities) connects to the target system, captures program records, and stores the output in the database to maintain historical data.

In an embodiment, the event module 308 may include a parser component as well as a comparator component. In an embodiment, the parser component includes a parser program that extracts keywords and values from event data. In an embodiment, the comparator component includes a comparator program that analyzes and compares the event data with historical data to identify completion or detect any abnormalities, such as changes or no changes in the metrics.

In the illustrated embodiment, the task module 310 manages the status and progress of each long-running job. In an embodiment, the task module 310 receives updates from the activity module 306 regarding the job's advancement and communicates with the response module 312 to execute responsive actions based on the events triggered. In an embodiment, the task module 310 also interacts with the optimization module 314 to optimize job scheduling and resource allocation.

In an embodiment, event module 308 maintains the status of monitoring events and is updated by the task module 310 as execution of the job progresses. In an embodiment, task module 310 reads the events generated during job monitoring, establishes a connection to the target system, and gathers and records the output produced by the target system. Further, task module 310 parses the output data to extract relevant information and compares the extracted information against historical data comprising previously captured metrics associated with the job. By validating the non-obvious status of the job through this comparison process, the task module 310 ensures that any anomalies or deviations from expected behavior are detected, transmitted, and addressed promptly. Throughout the job execution, the task module 310 may update the status in the event module 308 at every stage of the particular job execution, thereby providing real-time insights into the progress and performance of the task. This continuous monitoring and updating of event statuses enables the system to track the job's status accurately and respond effectively to any issues that may arise.

Further, upon completion or failure of the job, the task module 310 records the execution result into the system, capturing the outcome of the task execution. This recorded data provides valuable insights for future analysis, performance optimization, and decision-making within the job monitoring system. By integrating the event module 308 with the task module 310 in this manner, the system ensures comprehensive monitoring, validation, and recording of job execution results, enhancing the efficiency and reliability of job monitoring processes from start to finish.

In the illustrated embodiment, the response module 312 may action as metadata configured to record the execution status, such as for example, calling another API based on the reported status of the task module for any success, failure or non-obvious state. In an embodiment, the response module may be configured to trigger alert notifications to notify relevant stakeholders or administrators about critical events, anomalies, or failures detected during job execution. In an embodiment, the response module may be configured to automatically initiate remediation actions in response to certain event statuses indicating issues or failures, such as restarting a failed job, reallocating resources, or triggering a backup process. In an embodiment, the response module may be configured to automatically reallocate resources based on event statuses indicating resource constraints or bottlenecks to optimize performance and ensure job completion within specified parameters.

In an embodiment, the response module 312 may be configured to trigger escalation procedures for critical event statuses or sequences of job statuses indicating escalating issues, involving higher-level support or management for intervention. In an embodiment, the response module may be configured to initiate automated recovery processes in the event of job failures or unexpected outcomes to restore the system to a stable state and resume job execution. In an embodiment, the response module may be configured to dynamically adjust job scheduling based on event statuses indicating delays or dependencies to prioritize tasks, optimize job sequences, and minimize execution time. In an embodiment, the response module may be configured to trigger actions to optimize system performance in response to event statuses highlighting performance issues or inefficiencies, such as tuning parameters, adjusting configurations, or implementing caching strategies.

In an embodiment, the response module 312 may be configured to analyze historical data associated with event statuses to identify patterns, trends, or recurring issues, enabling proactive measures to prevent similar incidents in the future. Through these automated responsive actions, the response module 312 enhances the system's ability to proactively manage job execution, address issues in real-time, and optimize performance, ultimately improving the efficiency and reliability of job monitoring processes within the system.

In the illustrated embodiment, the optimization module 314 is responsible for optimizing the performance of the dynamic job monitor module 300 and/or the target system by analyzing job data, identifying bottlenecks, and suggesting improvements. In an embodiment, the optimization module 314 interacts with the task module 310 to access job information and with the model trainer module 316 to train predictive models for job optimization.

In an embodiment, the optimization module 314 leverages the trained prediction model, generated by the model trainer module 316, to automatically determine the optimal monitoring frequency and monitoring duration during the execution of long-running jobs. By integrating the predictive capabilities of the trained model, the optimization module 314 enhances the system's efficiency in monitoring tasks and identifying deviations from expected behavior.

In an embodiment, the optimization module utilizes the predictions from the trained model to dynamically adjust the monitoring frequency for each long-running job. Based on the job's characteristics, historical data, and real-time inputs, the module calculates the optimal frequency at which the system should monitor the job's status. This adaptive approach ensures that resources are allocated effectively and that critical checkpoints are monitored at the right intervals.

In an embodiment, the trained prediction model assists the optimization module 314 in detecting abnormal behavior during job execution. By comparing the actual job progress with the predicted outcomes, the module can identify deviations, anomalies, or unexpected patterns that may indicate potential issues or failures. In an embodiment, the optimization module provides a benchmark for normal job behavior, enabling the system to trigger alerts or take corrective actions when abnormal behavior is detected.

In an embodiment, the optimization module continuously analyzes the data generated by the prediction model and the ongoing job executions to fine-tune the monitoring frequency and monitoring duration for long-running jobs.

In an embodiment, the Optimization Module 314 leverages a regression model to determine an optimal monitoring frequency and duration for monitoring long-running jobs. The regression model is trained using historical job data, including job durations, monitoring frequencies, and outcomes, to identify patterns and relationships that influence the monitoring parameters. By analyzing the data, the regression model can predict the optimal frequency at which job statuses should be monitored and the duration for which monitoring should occur.

The Optimization Module utilizes the regression model to estimate the impact of different monitoring frequencies and durations on job performance and system efficiency. By considering factors such as job complexity, resource availability, and critical checkpoints, the regression model can recommend the most effective monitoring parameters for each job. This data-driven approach enables the module to dynamically adjust monitoring intervals and durations based on the specific characteristics of the tasks being monitored.

Through continuous learning and adaptation, the regression model within the Optimization Module can optimize monitoring processes, improve resource utilization, and enhance the overall efficiency of job monitoring. By leveraging predictive analytics and regression modeling, the module can proactively determine the optimal monitoring frequency and duration for long-running jobs, ensuring timely detection of issues, proactive intervention, and efficient management of tasks within the system.

In the illustrated embodiment, the model trainer module 316 trains machine learning models using historical job data to predict job outcomes, estimate completion times, and optimize resource allocation. In an embodiment, the model trainer module 316 outputs a trained machine learning model (“ML model”) that interacts with the optimization module 314 to provide insights for improving job scheduling and performance. In an embodiment, the machine learning model includes a regression model. In an embodiment, the model trainer module 316 trains a regression network on historical data stored on the system monitoring database to produce a trained regression network configured to generate an optimal frequency of monitoring events. In an embodiment, the model trainer module 316 trains a regression network on historical data stored on the system monitoring database to produce a trained regression network configured to generate an optimal duration for the monitoring activity.

In an embodiment, model trainer module 316 includes a data preparation module, algorithm module, training engine, and the machine learning model. In an embodiment, the model trainer module 316 includes a training engine configured to generate and/or train the machine learning model using a training dataset, resulting in trained machine learning model. In some embodiments, training dataset is divided into two discrete subsets, where one subset is used by training engine for initially training machine learning model. The other subset is used by training engine to test trained model and determine the accuracy of trained model.

In an embodiment, the training process begins by preprocessing the historical job data to extract relevant features such as job identifiers, expected durations, actual durations, monitoring frequencies, and any other pertinent information. These features are then used to train a machine learning algorithm, such as regression or classification models, to predict the optimal frequency of status monitoring and the duration of long-running jobs. In an embodiment, the machine learning model learns patterns and relationships within the historical data to make predictions about the monitoring frequency and job duration. By analyzing past job performances and monitoring patterns, the model can identify factors that influence the optimal monitoring frequency and duration, such as job complexity, resource availability, and critical checkpoints.

In an embodiment, once the model is trained and validated using historical data, the trained model can be deployed within the system to provide real-time predictions for new long-running jobs. For example, when a new job is created, the model can analyze its characteristics and recommend the optimal frequency for monitoring the job status and the expected duration for completion. The predictive model generated by the module enables the system to make data-driven decisions on how frequently to monitor job statuses and how long the jobs are expected to run, ultimately improving efficiency, resource utilization, and overall job performance.

In the illustrated embodiment, the API Interface 318 enables external applications to interact with the system programmatically. In an embodiment, API Interface 318 allows authorized users, developers, systems, programs, etc. to integrate the depicted system with other software tools, automate tasks, and retrieve job information. The API Interface 318 may interact with all modules to facilitate seamless communication between the system and external applications.

In the illustrated embodiment, the admin interface 320 provides an interface for administrators to manage and monitor the system. In an embodiment, admin interface 320 allows administrators to view job statuses, configure system settings, and access reports on job performance, as described in greater detail herein. The admin interface 320 interacts with all other modules to provide a comprehensive overview of the system's operations.

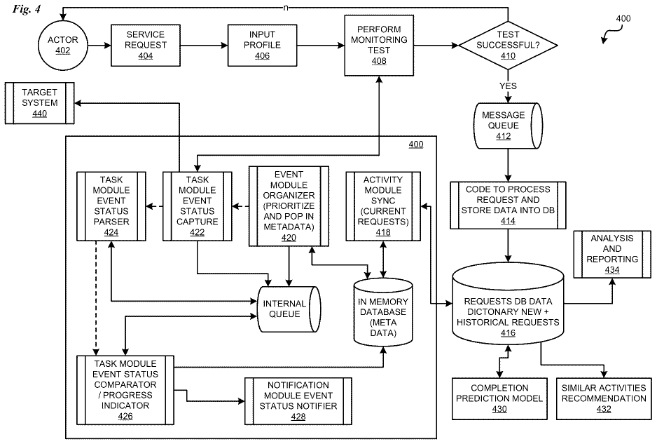

FIG. 4 depicts an example processing environment including dynamic job monitor module 400. In an embodiment, the dynamic job monitor module 400 of the depicted example processing environment may include dynamic job monitor module 200 of FIGS. 1 and 2, and/or dynamic job monitor module 300 of 3.

In the illustrated embodiment, a typical job monitoring process is shown. In the illustrated embodiment, actor 402 is shown tasked with a service request 404. In the illustrated embodiment, input profile 406 may be utilized by actor 402 to accomplish service request 404. In an embodiment, input profile 406 may include information related to execution of a particular job or task. For example, types of information that may in part form the input profile 406 may include, but are not limited to, commands, instructions, API details, targets, credentials, start time of a task, end time of a task, monitoring frequency, status, key-word identifier for status, (e.g.,: success, failure, hung, etc.), notification preferences, actor contact information, vendor contact information, and the like. In the illustrated embodiment, based on the input profile 406, the actor performs a monitoring test 408 corresponding to a system or system component identified in the service request 404 and/or input profile 406.

In the illustrated embodiment, at block 410, the process determines if the test was successful, and upon a determination that the test was successful, the test results are entered into a message queue 412. Further, at block 414, the successful service request is processed and stored into a request database 416. In an embodiment, the request database 416 includes

a data dictionary comprising historical data related to past successful service requests and may be updated each time a successful service request is accomplished. In an embodiment, blocks 402, 404, 406, 408, 410, 412, 414, and 416 collectively form a process of registering prime metadata corresponding to different jobs or tasks into a data dictionary which may be further utilized to accomplish automated self-tuning system monitoring.

In the illustrated embodiment, at block 418, the process connects to request database 416 to retrieve metadata to generate one or more jobs to be stored. Accordingly, at block 418, the process may be generating a queue for activities for which monitoring events are to be generated. An embodiment includes continuously connecting to the requests database 416 and synchronously creating activities in the in memory database of dynamic job monitor module 400. In the illustrated embodiment, block 420 includes a prioritizing queue for event generation, that likewise serves to ensure that duplicate events are not created.

In the illustrated embodiment, the task module 422 connects to target system 440 to capture the output of the target system 440. In an embodiment, this may include retrieving a current status of a job or task in progress on the target system 440. It is contemplated herein that task module 422 may connect to target system 440 via any suitable connection type or protocol, including but not limited, via API, HTTPS, SSH, or any other mode of establishing a connection a to system.

In the illustrated embodiment, block 424 includes a parser program configured to parse information captured from target system 440 by the task module 422. Accordingly, once the captured information is stored on the in-memory database, the parser program parses the data based on a predefined set of conditions to selectively obtain relevant metrics to be leveraged for system monitoring and job progression assessment. In the illustrated embodiment, block 426 includes a comparator program configured to perform comparison operations. For example, if there has never been an event generated for a particular activity, then there will be no historical data associated with that event, so the new event will be stored in the in-memory database for future comparison purposes. However, if there is historical data corresponding to the event, then at block 426 the comparator program compares the event to historical data to detect and/or identify a non-obvious or abnormal situation.

In the illustrated embodiment, block 430 includes a trained prediction model configured to predict the optimal monitoring frequency and monitoring duration for each job or task, as described in greater detail herein. Accordingly, the prediction model may utilize historical job data and one or more machine learning algorithms to predict the optimal frequency for monitoring the execution of a job and the duration of monitoring the job. By analyzing patterns, trends, and correlations in the data, the model can determine the most effective monitoring parameters to ensure efficient job execution and timely detection of issues. This predictive capability is especially useful for managing resources effectively in a heterogeneous system where hundreds of jobs may be executed simultaneously.

In the illustrated embodiment, block 432 includes a recommendation engine configured to recommend similar activities based on similarities to previously existing activities. In an embodiment, the recommendation engine for similar activities utilizes a predictive model that analyzes metrics from different databases with slight variances to make recommendations based on historical data. By identifying patterns and correlations in the metrics across various systems, the engine can predict and suggest similar activities for different databases. For instance, if the historical data shows that specific metrics have led to successful outcomes in one system, the recommendation engine can leverage this information to recommend similar activities for other systems. This predictive capability allows the engine to provide insights and recommendations based on past performance and trends, enabling users to make informed decisions and optimize activities across different databases with confidence.

In the illustrated embodiment, block 434 includes an analysis and reporting module configured to generate and transmit analytical data related to data stored on request database 416. Accordingly, request database 416 includes a data dictionary comprising historical data related to past successful service requests and may be updated each time a successful service request is accomplished. This module may be configured to perform various functions, including analyzing historical trends, identifying patterns in service request handling, and creating summaries or detailed reports to support decision-making processes. Further, the analysis and reporting module 434 may be configured to generate graphical elements, such as visual dashboards, charts, or alerts that highlight performance metrics, such as the frequency of successful service requests, average processing times, or common service categories.

In the illustrated embodiment, the dynamic job monitor module 400 leverages the comparator block 426 to determine the progress of a job. For example, the comparison to past event status may reveal, for example that the task is progressing as expected, or may instead detect anomalous behavior and determine that the task is not progressing and may be currently hung, or even may have failed entirely. Further, suppose a job or task is not progressing as

expected or desired, then based on the input profile 406, the dynamic job monitor module 400 may initiate a responsive action that is in accordance with the notification preferences defined by the input profile. However, it may be the case that a job is progressing as expected, in which case a different responsive action may be initiated. For example, suppose a job is actually progressing as expected, then at block 428 the notification module may generate a notification indicating the status of the progression of the task to a user.

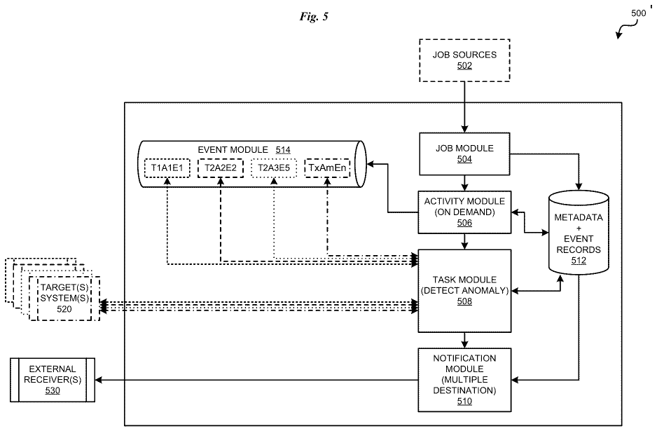

FIG. 5 depicts a block diagram of an example system architecture of a dynamic job monitor module in accordance with an illustrative embodiment. In the illustrated embodiment, the system 500 receives input from job sources 502 to initiate or define jobs to be monitored. Accordingly, input from job sources 502 may be processed by the job module 504 to generate one or more jobs. The activity module 506 operates on-demand and generates one or more specific activities associated with jobs in order to track. In the illustrated embodiment, the activity module 506 retrieves historical data and context from the metadata and event records repository 512, which stores job metadata and historical event logs for analysis and reference.

In the illustrated embodiment, the event module 514 dynamically creates and manages events representing status during monitoring execution of an activity. In some embodiments, events may be specifically defined for significant milestones, anomalies, or completion markers in the job lifecycle. Further, in accordance with the example embodiment depicted, the event module 514 may capture events corresponding to multiple systems and activities across those systems by monitoring and tracking the progress of each job or activity in real-time. For example, suppose a first event has been monitored and completed, while the second job is currently experiencing a second event. Similarly, other jobs may be at different stages, in their execution. In the illustrated embodiment, the event module 514 continuously monitors the status and progression of each job, capturing events as they occur and updating the system accordingly. By tracking events across multiple systems and activities, the module provides a comprehensive overview of job statuses, milestones, and potential issues, enabling effective monitoring, analysis, and decision-making in a dynamic and heterogeneous system environment.

In the illustrated embodiments, these events are logged and passed to the task module 508, which analyzes them for discrepancies or anomalies. The task module 508 uses metadata and historical event data to compare expected and actual job behavior. When anomalies are detected, the notification module 510 initiates corrective actions or flags issues for resolution. In the illustrated embodiment, the target system(s) 520 represents the external infrastructure where jobs are executed. Accordingly, the task module 508 interacts with the target system(s) 520 to retrieve status updates, execute actions, or resolve detected anomalies.

In the illustrated embodiment, once the task module 508 processes events, the task module 508 communicates with the notification module 510 which generates notifications for multiple destinations. These notifications ensure that stakeholders or automated systems are promptly informed about job statuses, detected anomalies, or resolutions. In the illustrated embodiment, the notifications are delivered to external receivers 530, which may include, but are not limited to, dashboards, users, and/or other endpoints. In the illustrated embodiment, the notification module 510 may be configured to perform an automated responsive action upon detection of unexpected and/or undesirable execution result from attempting to accomplish one or more jobs.

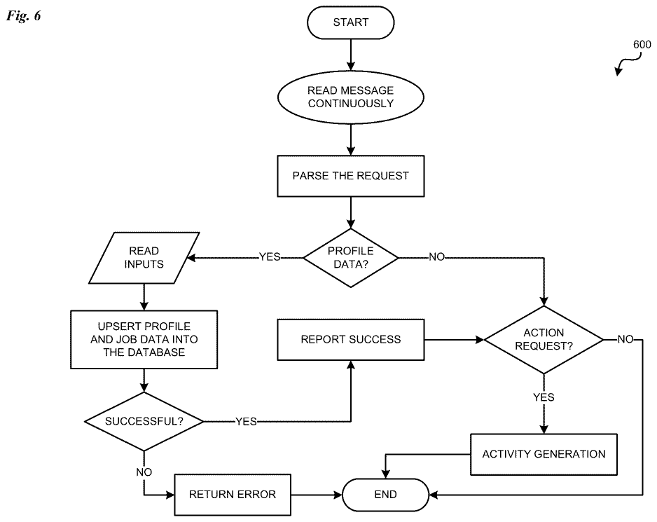

FIG. 6 depicts a flowchart of an example process for job registration. In an embodiment, the example process for job registration depicted is as part of the job monitoring system described in greater detail herein. The process 600 begins with the system continuously reading incoming messages to identify potential requests. Once a message is received, the system parses the message to determine its type. If the message contains profile data, the system reads the necessary inputs related to user profiles or job details and proceeds

to update or insert this data into the database. Afterward, it checks whether the operation was successful. If the operation succeeds, the system reports success and concludes the process; otherwise, it returns an error and terminates.

In the illustrated embodiment, if the request does not involve profile data, the system evaluates whether it is an action request. For action requests, the system generates the necessary activities, such as job monitoring or task execution. If the request is neither profile data nor an action request, the process ends without further action. At every step, the system ensures robust handling of operations, providing error feedback when needed and reporting success when tasks are completed. This approach ensures the efficient handling of job-related tasks while maintaining system reliability.

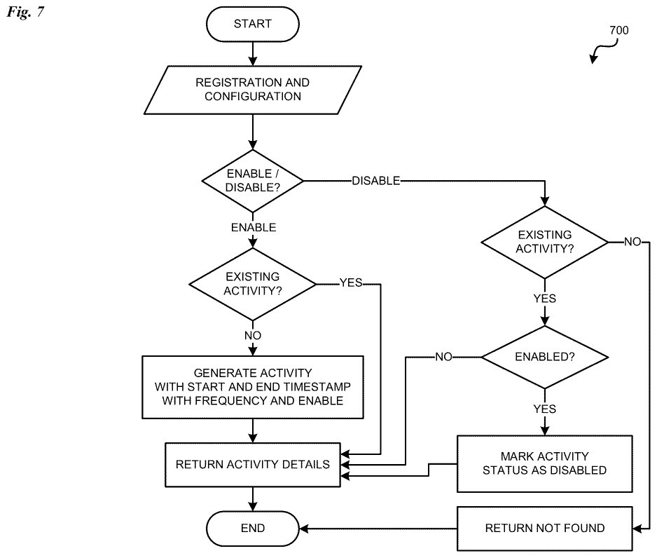

FIG. 7 depicts a flowchart of an example process for activity generation in accordance with an illustrative embodiment. In the illustrated embodiment, the process 700 begins with the registration and configuration of necessary components or entities. Following this, a decision is made to either enable or disable an activity. If the choice is to disable, the system checks whether an existing activity is present. If no such activity exists, the system returns “Not Found” and ends the process. If an activity is found, the system checks whether it is currently enabled. If the activity is enabled, its status is marked as disabled, and the activity details are returned.

In the illustrated embodiment, if the choice is to enable an activity, the system checks for the presence of an existing activity. If an activity is found, its details are returned directly. If no existing activity is found, the system generates a new activity, assigning the activity a start timestamp, an end timestamp, a frequency, and an enabled status. The details of the newly generated activity are then returned to the user or system. In both cases, whether enabling or disabling, the process ensures activities are managed without duplication, providing appropriate feedback or updates before concluding. This process is instrumental in system monitoring to manage and track activities efficiently.

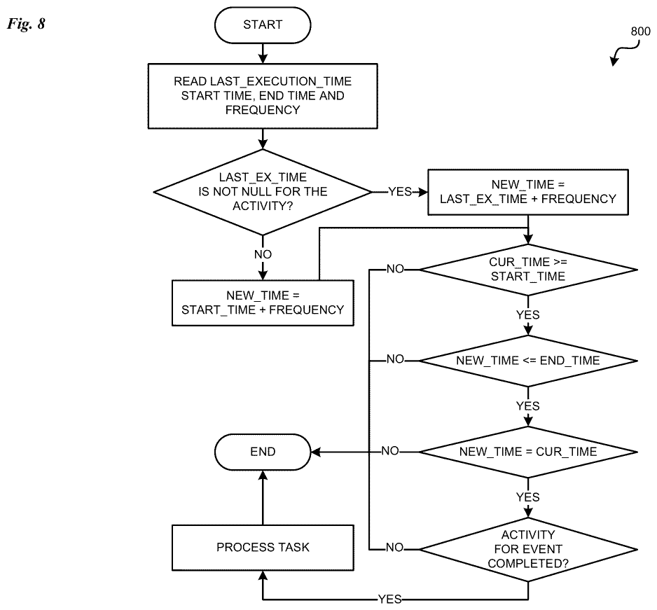

FIG. 8 depicts a flowchart of an example process for event generation in accordance with an illustrative embodiment. In the illustrated embodiment, the process 800 begins by reading key parameters: the last execution time (LAST_EXECUTION_TIME), the defined start time (START_TIME), the end time (END_TIME), and the interval frequency (FREQUENCY). The system first checks if the LAST_EXECUTION_TIME is not null, which indicates that the activity has not been executed before. If so, the NEW_TIME is set to LAST_EXECUTION_TIME+FREQUENCY. Otherwise, the NEW_TIME is calculated as START_TIME+FREQUENCY.

In the illustrated embodiment, the system checks if the current time (CUR_TIME) is greater than or equal to the START_TIME. If this condition is not met, the process ends without executing the task. If the condition is satisfied, the system verifies whether NEW_TIME is less than or equal to the END_TIME. If NEW_TIME exceeds END_TIME, the process concludes without execution. The system then checks if NEW_TIME equals CUR_TIME, ensuring the task is triggered at the correct time. If these conditions are not met, the task is not processed.

In the illustrated embodiment, the system confirms whether the activity associated with the event has already been completed. If it has, no further action is taken. However, if all conditions are satisfied, the system executes the task associated with the event. Once the task is processed, the workflow ends. This approach ensures that events are only triggered within the designated time window, at defined intervals, and prevents redundant or premature executions, making the process especially useful for tasks like periodic system monitoring or scheduled event triggers.

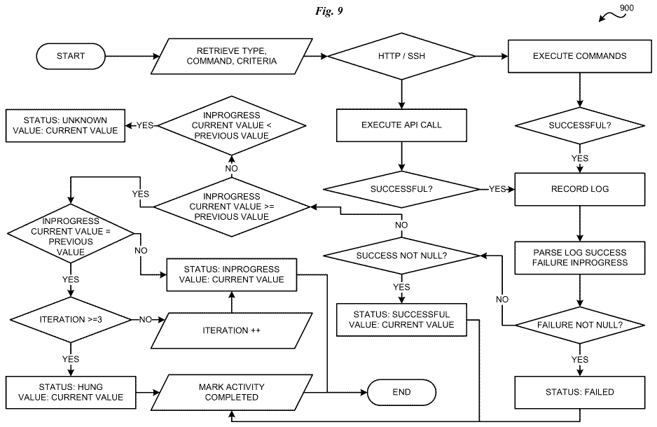

FIG. 9 depicts a flowchart of an example process for event execution, parsing, and notification in accordance with an illustrative embodiment. In the illustrated embodiment, the process 900 begins by initializing the system monitoring workflow, where the type of operation (such as HTTP or SSH), the specific command to be executed, and the relevant evaluation criteria are retrieved. Based on the operation type, the system determines whether to execute the task via a command (e.g., over SSH) or an API call. The command or API call is then executed, and its success is evaluated.

In the illustrated embodiment, if the execution is successful, the result is logged, and the activity is marked as complete, ending the process. If not, the system parses logs to determine the status, which can indicate success, failure, or an in-progress state. In the case of success, the status is updated to “Successful,” the current value is logged, and the process ends. If a failure condition is detected, the status is updated to “Failed,” the failure is logged, and the process is terminated.

In the illustrated embodiment, for operations still in progress, the system compares the current value with the previous value. If the current value is less than the previous value, the status is updated to “Unknown,” and monitoring continues. If the current value is greater than or equal to the previous value, the status remains as “In Progress.” The iteration count is then incremented. If the current value is equal to the previous value for 3 consecutive iterations, the system updates the status to “Hung” to indicate a stuck operation, marks the activity as completed, and ends the process. Otherwise, the process continues monitoring. In some embodiments, tasks are tracked until completion or timeout. This process ensures reliable system monitoring by dynamically managing various states of execution and outcomes, includes mechanisms for retries, detailed logging for success and failure, and the flexibility to handle in-progress evaluations.

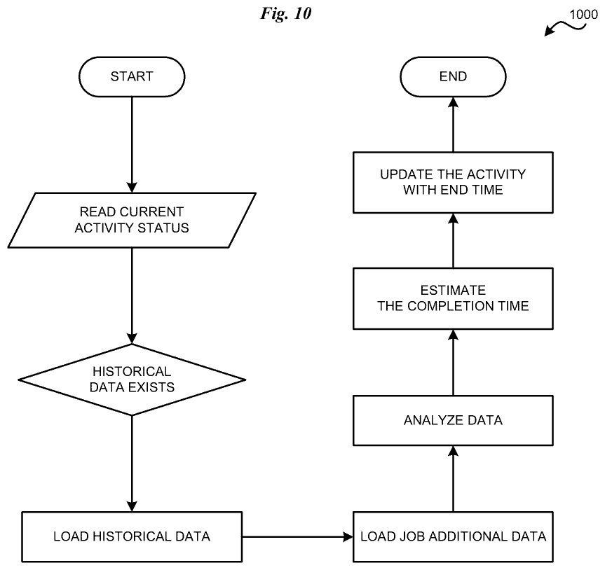

FIG. 10 depicts a flowchart of an example process for activity prediction in accordance with an illustrative embodiment. In the illustrated embodiment, the process 1000 begins with reading the current activity status to establish a baseline for the prediction process. The system then checks whether historical data exists. If historical data is available, it is loaded to provide context and reference for the activity. If not, the system proceeds without this data. Next, the system gathers additional data related to the job, such as real-time metrics, resource availability, or other relevant factors.

In the illustrated embodiment, once all necessary data is collected, the system analyzes it to identify patterns or trends that can inform predictions. Using the insights from the analysis, the system estimates the time required to complete the activity. This predicted completion time is then used to update the activity's record with an end time. Finally, the process concludes, ensuring accurate monitoring and prediction of activities, which supports better planning and resource management within the system.

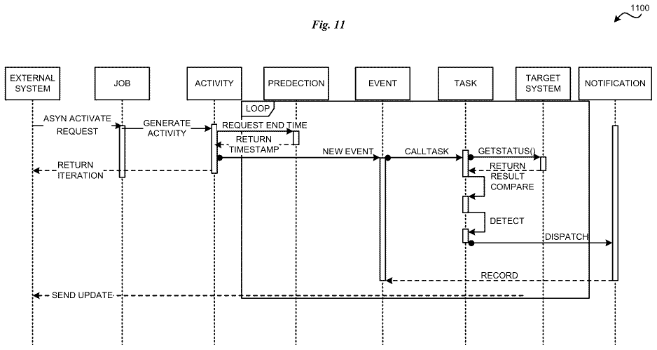

FIG. 11 depicts a sequence diagram for dynamic job monitoring in accordance with an illustrative embodiment. In the illustrated embodiment, the sequence diagram represents a dynamic job monitoring system 1100, illustrating interactions among multiple components of the system, including an external system, a job module, an activity module, a prediction module, a task module, the target system, and the notification module. In the illustrated embodiment, the process begins when the External System sends an asynchronous activation request to the job module, initiating the workflow. In response, the job module acknowledges the activation with a return iteration message, indicating that the activity generation process has started

In the illustrated embodiment, the job module triggers the activity module to generate a new activity, setting the groundwork for tracking and monitoring the specific task. Once the activity is created, the activity module sends a request to the prediction module to estimate the job's end time. The prediction module calculates the expected completion time based on current data and returns the predicted timestamp to the activity module. This interaction may be iteratively performed in a loop, allowing the system to dynamically update the predicted end time as the job progresses and new data becomes available.

In the illustrated embodiment, based on updates from the prediction module, the activity module generates a new event, which it forwards to the event module for further processing. The event module triggers the task module with a call task request, initiating actions required to address the event. The task module communicates with the target system by calling its GetStatus() function to retrieve real-time status updates on the job. The target system responds with the current status, which is then returned to the task component. The task component compares the received status against predefined thresholds or conditions. If discrepancies or completion signals are identified, the task component detects the issue or completion and marks the task for further action.

In the illustrated embodiment, following detection, the task module sends a dispatch request to the notification module, initiating communication with stakeholders. The notification module records the update and ensures that information about the job's progress or completion is delivered to the relevant parties. Finally, the Job component sends a summary update back to the external system, providing a complete status report on the monitored job.

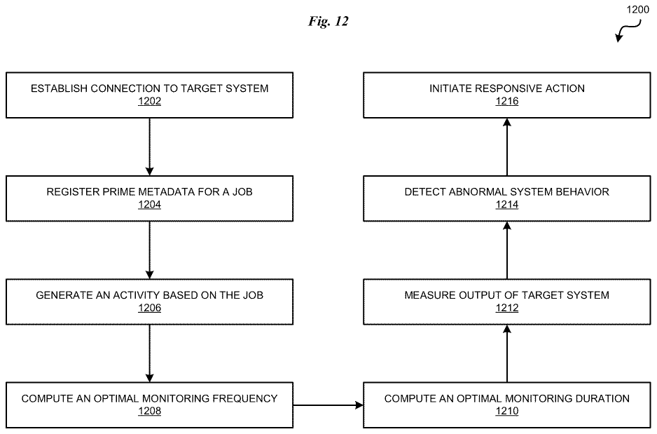

FIG. 12 depicts a flowchart of an example process dynamic job monitoring. In some particular embodiments, dynamic job monitor module 200 of FIGS. 1 and 2, and/or dynamic job monitor module 300 of FIG. 3 carries out process 1200.

In an embodiment, at step 1202, the process establishes a connection to a target system where a job is currently being executed, that may be executed in the future, or that previously has been executed in the past. This connection allows the monitoring system to access real-time data and monitor the progress of the job. In some embodiments, at step 1202, the process includes testing a connection to a target system, and the establishment of an on-going connection is performed in a later step.

In an embodiment, at step 1204, the process registers prime metadata for the job within a monitoring system. This prime metadata includes essential information such as job identifiers, expected durations, and critical checkpoints, providing the foundation for effective job monitoring.

In an embodiment, at step 1206, the process generates an activity based on the registered prime metadata for the job. In an embodiment, this activity details the specific tasks and processes to be monitored during the job execution, guiding the monitoring process.

In an embodiment, at step 1208, the process computes an optimal monitoring frequency for monitoring the job, determining the frequency at which the job status should be monitored to ensure timely detection of issues or anomalies. In an embodiment, at step 1210, the process computes an optimal monitoring duration for monitoring the job, considering factors such as job complexity, expected duration, and critical checkpoints to determine the duration of monitoring required. In an embodiment, after the process computes an optimal monitoring frequency and/or an optimal monitoring duration, the process includes establishing an on-going connection to the target system.

In an embodiment, at step 1212, the process measures the output of the target system during job execution, collecting data to assess job performance and progress. In an embodiment, at step 1214, the system continuously monitors the job to detect any abnormal situations or deviations from expected behavior. In an embodiment, at step 1216, upon detecting an abnormal situation, the process initiates a responsive action to address the issue, which may involve triggering alerts, notifying administrators, or implementing automated remediation processes to ensure the successful completion of the job.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
establishing a system monitoring database, the system monitoring database configured to store data corresponding to one or more jobs;
registering metadata associated with a first job;
generating a monitoring activity corresponding to the first job based on the metadata associated with the first job;
generating a first event corresponding the monitoring activity, the first event comprising a status of the first event;
capturing a first output of a target system during execution of the first job over the target system;
comparatively computing the first output of the target system during execution of the first job over the target system to the status of the first event to determine a progress state of the first job; and
initiating a responsive action based on the progress state of the first job.

2. The computer-implemented method of claim 1, further comprising training a regression network on historical data stored on the system monitoring database to produce a trained regression network configured to generate an optimal frequency of monitoring events.

3. The computer-implemented method of claim 1, further comprising training a regression network on historical data stored on the system monitoring database to produce a trained regression network configured to generate an optimal duration for the monitoring activity.

4. The computer-implemented method of claim 1, wherein the initiating the responsive action based on the progress state of the first job comprises transmitting a notification signal to a first endpoint.

5. The computer-implemented method of claim 1, wherein the initiating the responsive action based on the progress state of the first job comprises establishing connection with a first external system via a first application programming interface of the first external system.

6. The computer-implemented method of claim 1, wherein the progress state indicates an expected execution result associated with the first job at a first moment in time.

7. The computer-implemented method of claim 1, wherein the progress state indicates an unexpected execution result associated with the first job at a first moment in time.

8. The computer-implemented method of claim 7, initiating the responsive action comprises restarting execution of the first job over the target system.

9. The computer-implemented method of claim 7, further comprising recording context data corresponding to the unexpected execution result in a data dictionary, the data dictionary defining a plurality of outputs of the target system with a plurality of event statuses.

10. A computer program product comprising one or more computer readable storage media, and program instructions collectively stored on the one or more computer readable storage media, the program instructions executable by a processor to cause the processor to perform operations comprising:
establishing a system monitoring database, the system monitoring database configured to store data corresponding to one or more jobs;
registering metadata associated with a first job;
generating a monitoring activity corresponding to the first job based on the metadata associated with the first job;
generating a first event corresponding the monitoring activity, the event comprising a status of the first event;
capturing a first output of a target system during execution of the first job over the target system;
comparatively computing the first output of the target system during execution of the first job over the target system to the status of the first event to determine a progress state of the first job; and
initiating a responsive action based on the progress state of the first job.

11. The computer program product of claim 10, wherein the stored program instructions are stored in a computer readable storage device in a data processing system, and wherein the stored program instructions are transferred over a network from a remote data processing system.

12. The computer program product of claim 10, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

13. The computer program product of claim 10, further comprising training a regression network on historical data stored on the system monitoring database to produce a trained regression network configured to generate an optimal frequency of monitoring events.

14. The computer program product of claim 10, further comprising training a regression network on historical data stored on the system monitoring database to produce a trained regression network configured to generate an optimal duration for the monitoring activity.

15. The computer program product of claim 10, wherein the progress state indicates an expected execution result associated with the first job at a first moment in time.

16. The computer program product of claim 10, wherein the progress state indicates an unexpected execution result associated with the first job at a first moment in time.

17. The computer program product of claim 16, wherein the initiating the responsive action comprises restarting execution of the first job over the target system.

18. A computer system comprising a processor and one or more computer readable storage media, and program instructions collectively stored on the one or more computer readable storage media, the program instructions executable by the processor to cause the processor to perform operations comprising:
establishing a system monitoring database, the system monitoring database configured to store data corresponding to one or more jobs;
registering metadata associated with a first job;
generating a monitoring activity corresponding to the first job based on the metadata associated with the first job;
generating a first event corresponding the monitoring activity, the first event comprising a status of the first event;
capturing a first output of a target system during execution of the first job over the target system;
comparatively computing the first output of the target system during execution of the first job over the target system to the status of the first event to determine a progress state of the first job; and
initiating a responsive action based on the progress state of the first job.

19. The computer system of claim 18, further comprising training a regression network on historical data stored on the system monitoring database to produce a trained regression network configured to generate an optimal frequency of monitoring events.

20. The computer system of claim 18, further comprising training a regression network on historical data stored on the system monitoring database to produce a trained regression network configured to generate an optimal duration for the monitoring activity.
